(19) United States
(12) Patent Application Publication
(10) Pub. No.: US 2012/0106636 A1
(43) Pub. Date: May 3, 2012

(54) IMAGE ENCODING/DECODING METHOD AND APPARATUS

(75) Inventors: Sunyeon Kim, Seoul (KR); Jeongyeon Lim, Gyeonggi-do (KR); Byeungwoo Jeon, Gyeonggi-do (KR); Joohee Moon, Seoul (KR); Yunglyul Lee, Seoul (KR); Haekwang Kim, Seoul (KR); Jongki Han, Seoul (KR); Jungyoup Yang, Seoul (KR); Donguk Kim, Incheon (KR)

(73) Assignee: SK TELECOM CO., LTD., Seoul (KR)

(21) Appl. No.: 13/382,275

(22) PCT Filed: Jul. 2, 2010
(86) PCT No.: PCT/KR2010/004323

§ 371 Date: Jan. 13, 2012

(30) Foreign Application Priority Data
Jul. 4, 2009 (KR) 10-2009-0060898

(51) Int. Cl. H04N 7/32

(52) U.S. Cl. 375/240.12; 375/E07.243

(57) ABSTRACT

The present disclosure relates to a video encoding/decoding method and provides a video encoding apparatus including: an intra-prediction mode determiner for determining an intra prediction mode of current block entitled an encoder prediction mode by using candidate intra-predictable mode set including intra-prediction mode candidates being selected from a whole and predictable by video decoding apparatus; an encoder for encoding residual block from subtracting predicted block from predicting the current block by the encoder prediction mode from current block; a mode information generator for generating mode information depending on whether the video decoding apparatus can predict the encoder prediction mode; and an encoded data generator for generating encoded data including an encoded residual block and the mode information. The present disclosure selectively encodes mode information on the intra-prediction mode to reduce the bit rate of encoded data from encoding video and improve video compression efficiency and quality of compressed video.

### TECHNICAL FIELD

The present disclosure relates to a video encoding/decoding method. More particularly, the present disclosure relates to a method and apparatus for improving the compression efficiency of video and the quality of compressed video by selectively encoding mode information on the intra-prediction mode to decrease the quantity of bits of encoded data.

### BACKGROUND ART

The statements in this section merely provide background information related to the present disclosure and may not constitute the prior art.

Different from existing video coding methods of the international standard techniques such as MPEG-1, MPEG-2, and MPEG-4 Part2 Visual, the intra coding based on H.264/AVC (hereinafter abbreviated as ‘H.264’) employs the spatial predictive coding method.

The intra coding by using the conventional video coding methods of MPEG-2, H.263 and the like employs the “intra prediction” for coefficients transformed in discrete cosine transform domain (or DCT transform domain) pursuing higher encoding efficiency but generally fails to obtain sufficient compression efficiency at low band transmission bit rates, which leads to degradation of the subjective video quality. However, H.264 adopts an encoding method based on a spatial intra prediction in a spatial domain rather than in a transform domain to resolve the existing problem to some extent.

Such an encoder using the encoding method based on the conventional spatial intra predictions predicts the pixels of a current block to be encoded from the pixels in the previous reconstructed blocks which are decoded after encoding, encodes only the differences of the predicted block pixel values from pixels values of the current block and, transmits the encoded difference information to a decoder. At this time, the encoder transmits parameters needed for predicting the block pixels, i.e. information on the intra-prediction mode, to the decoder, or both the encoder and the decoder may be made to use only a predefined intra-prediction mode known to them, so that the decoder in unison with the encoder performs the predictions so that simple transmission of encoded data of the difference of the predicted block pixel value from the original pixel value helps to find the original block value. If it is arranged to exclusively use a previously defined intra-prediction mode, then it would become unnecessary to supply information on what intra-prediction mode was used, however, the non-stationary nature of the general video deteriorates the prediction efficiency defying the expectation of an effective video compression. Therefore, at every event of block encoding, the intra-prediction mode of the corresponding block should be encoded and transmitted. If it is necessary to encode and transmit the intra-prediction mode information per block, the amount of bits generated from the encoding operation on the intra-prediction mode information increases, which accordingly increases the amount of data in encoding the video and leads to degradation of the overall video compression performance.

### DISCLOSURE

### Technical Problem

Therefore, the present disclosure is for use in video compression through intra-prediction to reduce the bit amount of encoded data from encoding a video by selectively encoding mode information on an intra-prediction mode and thereby improve the video compression efficiency and the quality of the compressed video.

### Technical Solution

One aspect of the present disclosure provides a video encoding apparatus including: an intra-prediction mode determiner for determining an intra prediction mode of a current block entitled an encoder prediction mode by using a candidate intra-predictable mode set including intra-prediction mode candidates being selected from a whole and predictable by a video decoding apparatus; an encoder for encoding a residual block generated by subtracting a predicted block from predicting the current block according to the encoder prediction mode from the current block; a mode information generator for generating mode information depending on whether or not the video decoding apparatus can predict the encoder prediction mode; and an encoded data generator for generating encoded data including an encoded residual block and the mode information.

Here, the intra-prediction mode determiner may be responsive to the number of the intra-prediction mode candidates in the candidate intra-predictable mode set being equal to or greater than a preset number for determining the encoder prediction mode by using a predetermined first intra-prediction mode selection method. In addition, the first intra-prediction mode selection method may determine a single intra-prediction mode candidate being selected from the intra-prediction mode candidates in the candidate intra-predictable mode set and satisfying a predetermined optimal encoding criterion as the encoder prediction mode, and the first intra-prediction mode selection method may decide that the predetermined optimal encoding criterion is satisfied if a rate-distortion cost is low, the rate-distortion cost considering a bit rate and a distortion occurring from predicting and encoding the current block for each of the intra-prediction mode candidates in the candidate intra-predictable mode set.

In addition, the intra-prediction mode determiner may be responsive to the number of the intra-prediction mode candidates in the candidate intra-predictable mode set being less than a preset number for determining the encoder prediction mode by using a predetermined second intra-prediction mode selection method. At this time, the second intra-prediction mode selection method may be for determining a most probable mode of a corresponding block as the encoder prediction mode.

In addition, the mode information generator may generate combined encoding mode information for identifying a combined encoding mode for blocks in a predetermined encoding unit as the mode information, where the mode information generator may determine a combined predictable mode as the combined encoding mode from a decision that the video decoding apparatus can predict encoder prediction modes of entire blocks in the predetermined encoding unit, the mode information generator may determine a combined unpredictable mode as the combined encoding mode from a decision that the video decoding apparatus cannot predict the encoder prediction modes of the entire blocks in the predetermined encoding unit, the mode information generator may determine a mixed mode as the combined encoding mode from a decision that the video decoding apparatus can selectively predict the encoder prediction modes of the blocks in the predetermined encoding unit, the mode information generator may operate on each of the blocks in the predetermined encoding unit for generating a predictability identifier for identifying whether or not the video decoding apparatus can predict the encoder prediction mode of said each of the blocks and including the predictability identifier as an addition in the mode information, and the mode information generator may operate on the block having the encoder prediction mode decided to be unpredictable by the video decoding apparatus for generating a prediction mode identifier for identifying the encoder prediction mode and including the prediction mode identifier as an addition in the mode information.

Another aspect of the present disclosure provides a video encoding method including: determining an intra prediction mode of a current block entitled an encoder prediction mode by using a candidate intra-predictable mode set including intra-prediction mode candidates being selected from a whole and predictable by a video decoding apparatus; encoding a residual block generated by subtracting a predicted block from predicting the current block according to the encoder prediction mode from the current block; generating mode information depending on whether or not the video decoding apparatus can predict the encoder prediction mode; and generating encoded data including an encoded residual block and the mode information.

Yet another aspect of the present disclosure provides a video decoding apparatus including: a mode information extractor for extracting mode information from encoded data; a first intra-prediction mode determiner for determining an intra-prediction mode by using a first intra-prediction mode selection method with respect to the entirety of blocks included in a predetermined encoding unit if a combined encoding mode identified by the mode information is a combined predictable mode and with respect to the blocks being selected from the entirety included in the predetermined encoding unit and indicated as predictable by a predictability identifier identified by the mode information if the combined encoding mode is a mixed mode; a second intra-prediction mode determiner for determining the intra-prediction mode by using a second intra-prediction mode selection method with respect to the entirety of blocks included in the predetermined encoding unit if the combined encoding mode identified by the mode information is a combined unpredictable mode and with respect to the blocks being selected from the entirety included in the predetermined encoding unit and indicated as unpredictable by the predictability identifier identified by the mode information if the combined encoding mode is the mixed mode; and a decoder for decoding and reconstructing an encoded residual block for each of blocks extracted from the encoded block and adding a reconstructed residual block to a predicted block from predicting each block according to an intra-prediction mode of each block determined by the first intra-prediction mode determiner or the second intra-prediction mode determiner.

Yet another aspect of the present disclosure provides a video decoding method including: extracting mode information and an encoded residual block from encoded data; decoding and then reconstructing the encoded residual block; determining an intra-prediction mode selection method according to extracted mode information; determining an intra-prediction mode of a block by using a determined intra-prediction mode selection method; and reconstructing the block by using a reconstructed residual block and a predicted block generated from predicting the block by using the determined intra-prediction mode selection method.

Here, the step of determining the intra-prediction mode selection method may include: deciding whether or not a combined encoding mode identified by the mode information is a mixed mode; extracting a predictability identifier for each of blocks in a predetermined unit if the combined encoding mode is the mixed mode; determining the intra-prediction mode of the block by using a first intra-prediction mode selection method if the predictability identifier indicates a positive predictability; determining the intra-prediction mode of the block by using a second intra-prediction mode selection method if the predictability identifier indicates a negative predictability; deciding whether or not the combined encoding mode is a combined predictable mode if the combined encoding mode is not the mixed mode; determining the intra-prediction mode by using the first intra-prediction mode selection method with respect to the entirety of blocks in the predetermined unit if the combined encoding mode is the combined predictable mode; and determining the intra-prediction mode by using the second intra-prediction mode selection method with respect to the entirety of blocks in the predetermined unit if the combined encoding mode is the combined unpredictable mode.

### Advantageous Effects

According to the present disclosure as described above, the present disclosure can lead to a reduction of the bit amount of encoded data from encoding a video by selectively encoding mode information on an intra-prediction mode and thereby improve the video compression efficiency and the quality of the compressed video.

### DESCRIPTION OF DRAWINGS

FIGS. 1 and 2 are exemplary diagrams of nine intra-prediction modes for conventional intra 4×4 prediction according to H.264/AVC standard;

FIG. 3 is an exemplary diagram showing a process of encoding the intra-prediction modes according to H.264/AVC standard;

FIG. 4 is a schematic block diagram of a video encoding apparatus according to an aspect;

FIG. 5 is a schematic block diagram of a prediction mode determiner according to an aspect;

FIG. 6 is a schematic block diagram of a mode information generator according to an aspect;

FIG. 7 is a flow diagram for illustrating a video encoding method according to an aspect;

FIG. 8 is a schematic block diagram of a video decoding apparatus according to an aspect;

FIG. 9 is a flow diagram for illustrating a video decoding method according to an aspect;

FIG. 10 is a flow diagram for illustrating an exemplary video decoding method according to an aspect;

FIG. 11 is an exemplary diagram for illustrating a boundary pixel matching algorithm; and

FIG. 12 is an exemplary diagram for illustrating empirical results according to an aspect, representing comparisons of rate-distortion performances of HD video.

### MODE FOR INVENTION

Hereinafter, aspects of the present disclosure will be described in detail with reference to the accompanying drawings. In the following description, the same elements will be rather designated by the same reference numerals although they are shown in different drawings. Further, in the following description of the present disclosure, a detailed description of known functions and configurations incorporated herein will be omitted when it possibly makes the subject matter of the present disclosure unclear.

Additionally, in describing the components of the present disclosure, there may be terms used like first, second, A, B, (a), and (b). These are solely for the purpose of differentiating one component from the other but not to imply or suggest the substances, order or sequence of the components. If a component were described as ‘connected’, ‘coupled’, or ‘linked’ to another component, they may mean the components are not only directly ‘connected’, ‘coupled’, or ‘linked’ but also are indirectly ‘connected’, ‘coupled’, or ‘linked’ via a third component.

A video encoding apparatus encodes an intra-prediction mode that is used for the prediction in performing an intra-prediction encoding on an image, and then a video decoding apparatus decodes the intra-prediction mode in performing an intra-prediction decoding on the image. In this event, an intra-prediction mode of a neighboring block having been encoded or decoded is used as a basis for predicting and encoding the intra-prediction mode of the outstanding block to be encoded or decoded. In the following, a certain predetermined method for directly encoding an intra-prediction mode or using predefined neighboring block intra-prediction mode to predict and encode the current block intra-prediction mode is called ‘default encoding/decoding method’.

For example, intra-prediction mode encoding/decoding process of H.264/AVC standard is as follows:

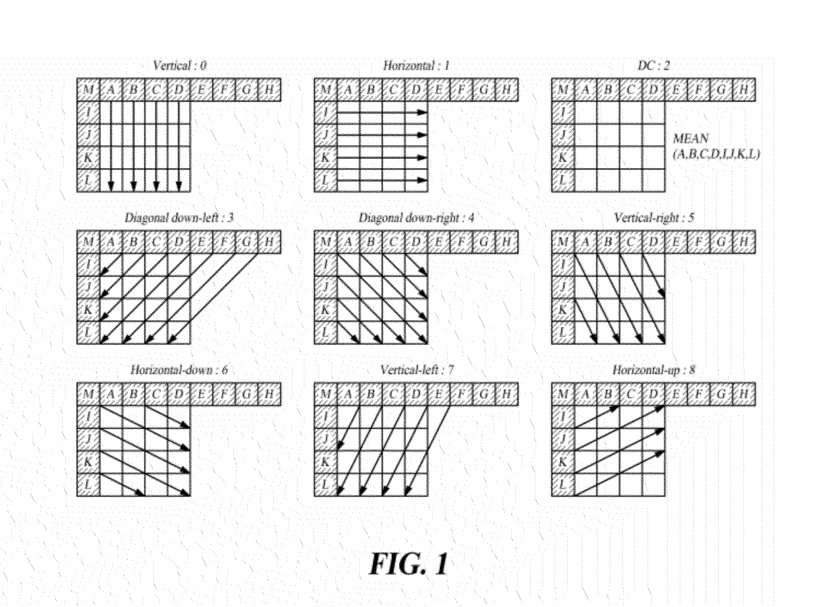

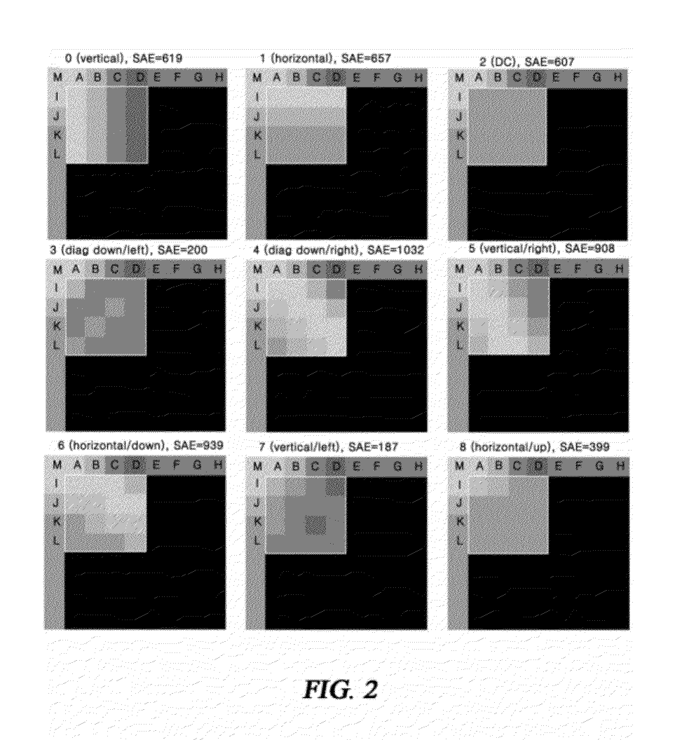

FIGS. 1 and 2 are exemplary diagrams of nine intra-prediction modes for conventional intra_{—}4×4 prediction according to H.264/AVC standard.

According to H.264/AVC standard, there are prediction modes for carrying out intra-predictions on macroblocks such as intra_{—}4×4 prediction, intra_{—}8×8 prediction, intra_{—}16×16 prediction and the like. For the intra_{—}4×4 prediction, there are nine prediction modes as shown in FIG. 1 including a vertical mode, horizontal mode, direct current (DC) mode, diagonal down-left mode, diagonal down-right mode, vertical-right mode, horizontal-down mode, vertical-left mode and horizontal-up mode. In addition, the intra_{—}8×8 prediction has nine modes similar to the intra_{—}4×4 prediction. The intra_{—}16×16 prediction uses four prediction modes which include a vertical mode, horizontal mode, DC mode and plane mode.

The blocks to be encoded such as macroblocks or sub-blocks are predicted in accordance with the intra-prediction modes wherein an optimal prediction mode is determined for the block to be currently encoded or the current block from the plurality of prediction modes as described above, predicted values are generated in accordance with the determined prediction mode. Here, the optimal prediction mode refers to a prediction mode determined by selecting an optimal value by a predetermined criterion from various intra-prediction modes for performing the intra-prediction (i.e., respectively nine modes in the intra_{—}8×8 prediction and the intra_{—}4×4 prediction and four modes in the intra_{—}16×16 prediction). Here, the optimal value by the predetermined criterion may be the prediction mode determined as having the lowest encoding cost, for example.

In order for a video decoding apparatus to identify the prediction modes of respective current blocks and to compute the same prediction values of the current blocks as in the video encoding apparatus, the prediction modes of the respective current blocks should be transmitted from the video encoding apparatus to the decoding apparatus wherein the H.264/AVC technique requires about four bits of data for transmitting information on the respective current block prediction modes.

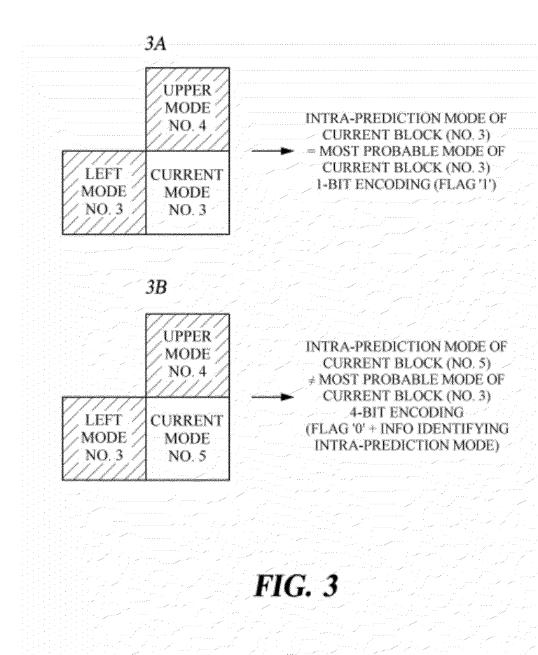

FIG. 3 is an exemplary diagram showing a process of encoding the intra-prediction modes according to H.264/AVC standard.

In H.264/AVC, when encoding the prediction mode of the current block, an estimated value of the intra-prediction mode of the current block is calculated from the prediction modes of neighboring blocks, i.e. the upper blocks and left side blocks of the current block and the calculated estimated value is used in encoding the intra-prediction mode of the current block. Here, the estimated value of the intra-prediction mode is also called most probable mode (MPM).

The most probable mode of the current block is determined as the intra-prediction mode having the smallest among the mode numbers identifying the intra-prediction modes of the left block and upper block of the current block. To illustrate the method of calculating the estimated value of the intra-prediction mode of the current block from the intra-prediction modes of the neighboring blocks referring to FIGS. 3A and 3B, the mode number 3 is for the left block and the mode number 4 is for the upper block, and hence the smaller intra-prediction mode 3 becomes the most probable mode of the current block. Therefore, the most probable mode is 3.

When encoding the intra-prediction mode of the current block, the video decoding apparatus compares the most probable mode of the current block with the predetermined intra-prediction mode of the current block to determine if they are identical and then use a method of thereby representing the intra-prediction modes of the current blocks differently in encoding the intra-prediction mode.

In other words, as shown in FIG. 3A, if the intra-prediction mode of the current block and the most probable mode are identical, the video encoding apparatus encodes a 1-bit flag (for example, ‘1’) for indicating the equality of the two modes (i.e. the current block intra-prediction mode is the current block most probable mode). To the contrary, as shown in FIG. 3B, if the intra-prediction mode of the current block and the most probable mode of the current block are not identical, the video encoding apparatus encodes a 1-bit flag (for example, ‘0’) for indicating the inequality of the two modes and should encode the identity information of any one of the other modes among candidate intra-prediction modes than the most probable mode, spending extra 3 bits for encoding this information in the intra_{—}4×4 prediction of H.264/AVC.

If predictions are formed with respect to the intra-prediction mode in this way, where the current block has an intra-prediction mode identical to the most probable mode, the compression performance may be considered improved because only 1-bit flag is to be encoded. However, when the current block intra-prediction mode is not identical to the current block most probable mode, total 4 bits (1 bit for the flag plus 3 bits for identifying the intra-prediction mode) are to be encoded, which constraints the compression performance and therefore hinders achieving an improved compression efficiency.

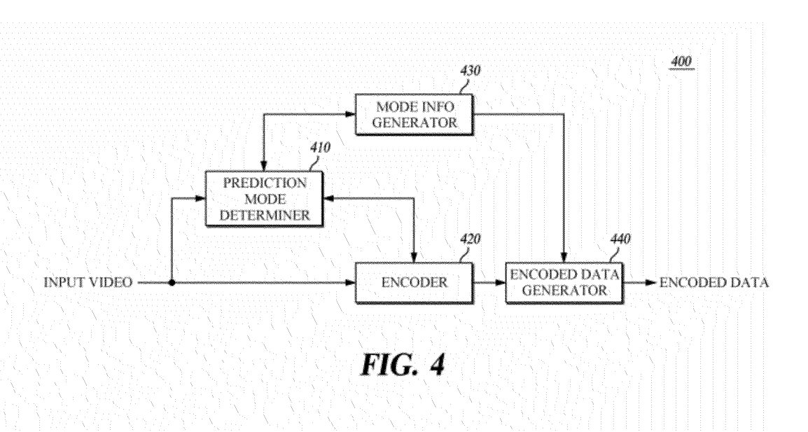

FIG. 4 is a schematic block diagram of a video encoding apparatus 400 according to an aspect of the present disclosure.

Video encoding apparatus 400 may be comprised of a prediction mode determiner 410, an encoder 420, a mode info generator 430, and an encoded data generator 440. Video encoding apparatus 400 may be a personal computer or PC, notebook or laptop computer, personal digital assistant or PDA, portable multimedia player or PMP, PlayStation Portable or PSP, or mobile communication terminal, smart phone or such devices, and represent a variety of apparatuses equipped with, for example, a communication device such as a modem for carrying out communications between various devices or wired/wireless communication networks, a memory for storing various programs for encoding videos and related data, and a microprocessor for executing the programs to effect operations and controls.

Prediction mode determiner 410 predicts an encoder prediction mode i.e., an intra-prediction mode of a current block. In other words, prediction mode determiner 410 predicts the encoder prediction mode which is the intra-prediction mode for use in predicting the current block in video encoding apparatus 400. To this end, prediction mode determiner 410 may define a number N of candidate intra-prediction modes in a set which can be used by video encoding apparatus 400 as the current block intra-prediction mode and make a selection, from the candidate intra-prediction modes included in the defined set of N candidate intra-prediction modes, of one intra-prediction mode as the current block intra-prediction mode by a predetermined method for selecting an intra-prediction mode.

For example, prediction mode determiner 410 defines a set of N candidate intra-prediction modes (candidate set, CS) available for use as current block intra-prediction modes, determines against each of the candidate intra-prediction modes included in the candidate intra-prediction mode set whether the video decoding apparatus can predict the corresponding candidate intra-prediction mode by a predetermined criterion of determining a predictability by the decoding apparatus (that is, whether there is a decoder predictability), and then reconstitutes a candidate intra-predictable mode set (candidate set prime, CS′) which includes just M (N≧M) candidate intra-prediction modes being predictable by the video decoding apparatus out of the candidate intra-prediction modes.

Thereafter, if a preset number (for example, 1) or more of candidate intra-prediction modes are available in the reconstructed candidate intra-predictable mode set (that is, M≧preset number), prediction mode determiner 410 determines that the encoder prediction mode is predictable in the video decoding apparatus and then determines the encoder prediction mode that is the current block intra-prediction mode according to a set first intra-prediction mode selection method prearranged with the video decoding apparatus. In addition, if the candidate intra-prediction modes less than the preset number (for example, 1) are available in the reconstructed candidate intra-predictable mode set (that is, M<preset number), prediction mode determiner 410 determines that the encoder prediction mode is unpredictable in the video decoding apparatus and then determines the encoder prediction mode that is the current block intra-prediction mode according to a second method predetermined for selecting the intra-prediction mode and prearranged with the video decoding apparatus.

In addition, prediction mode determiner 410 may first perform the above method of operations with respect to all of the blocks belonged to a predetermined encoding unit (for example, by macroblocks or slices), and selectively determine a combined encoding mode by a predetermined optimal encoding criterion (for example, rate-distortion optimal criterion). Here, the combined encoding mode may be determined into one of a combined predictable mode, a combined unpredictable mode, and a mixed mode against the predetermined encoding unit.

By definition, the combined predictable mode is a mode for representing that all of the blocks included in the predetermined encoding unit have their encoder prediction modes determined according to the first method of selecting the intra-prediction mode, the combined unpredictable mode is a mode for representing that all of the blocks included in the predetermined encoding unit have their encoder prediction modes determined according to the second method of selecting the intra-prediction mode, and the mixed mode is a mode for representing that the blocks included in the predetermined encoding unit have their encoder prediction modes determined according to a selection between the first and second methods of selecting the intra-prediction mode.

However, definitions of the combined predictable mode, combined unpredictable mode, and mixed mode as mentioned above may be made with various modifications depending on applications of the present aspect in different implementations. For example, a third method predetermined for selecting the intra-prediction mode different from the second method for selecting the same may be additionally defined. In other words, if it is determined that there are less than the preset number of the candidate intra-prediction modes included in the reconstructed candidate intra-predictable mode set and the encoder prediction mode is unpredictable by the video decoding apparatus, then the predetermined second method for selecting the intra-prediction mode may be redefined that all of the blocks included in the predetermined encoding unit have the most probable modes determined as the encoder prediction modes, and the predetermined third method for selecting the intra-prediction mode may be redefined similar to the intra-prediction mode encoding method of H.264/AVC that the methods for encoding the most probable modes and intra-prediction modes are to be selectively used. Therefore, variably defining the combined predictable mode, combined unpredictable mode, and mixed mode allows more diversified definitions of the combined encoding modes for determining the intra-prediction modes in the predetermined encoding unit.

Encoder 420 encodes a residual block generated by subtracting a predicted block from the current block, wherein the predicted block is generated by predicting the current block according to encoder intra-prediction mode ipmₒₚₜ determined by prediction mode determiner 410. To be specific, encoder 420 predicts each of the pixels in the current block in a prediction direction of the encoder prediction mode determined by prediction mode determiner 410 using adjacent pixels in the neighboring blocks to generate a predicted block and subtracts the predicted block from the current block to generate the residual block having a residual signal. In addition, the residual signal of the residual block undergoes a transform and a quantization and thereafter the quantized frequency-coefficients are encoded. Here, the residual block is arranged to have the residual signal or a difference between pixel values calculated by subtracting the predicted pixel values of each predicted block from the original pixel values of each current block.

As for the method of transform, discrete cosine transform (DCT) or integer DCT or its modified transform or Hadamard transform may be used, although there is no limitation to use other improved or modified DCT transform techniques, which will transform the residual signal first into the frequency domain and then to the frequency-coefficients. For the quantization method, a dead zone uniform threshold quantization (DZUTQ) or a quantization weighted matrix may be used, although their improvements or other variants of quantization are acceptable as well. For the encoding technique, an entropy encoding would work, but it is not to limit employing other various encoding techniques.

Depending on the result of determination of whether the decoding apparatus can predict the intra-prediction mode determined in prediction mode determiner 410, mode info generator 430 generates a predictability identifier of the encoder prediction mode, and if necessary, generates a prediction mode identifier for identifying the encoder prediction mode. In the case, the predictability identifiers for each of the blocks included in a predetermined encoding unit and by the unit may be combined according to the combined encoding mode determined by prediction mode determiner 410 to generate combined encoding mode information. Here, the predetermined encoding unit is preferably a macroblock but may include other various encoding units such as a slice or picture.

Encoded data generator 440 generates encoded data that includes the encoded residual block and the mode information. Here, the information includes the combined encoding mode information, predictability identifier, and prediction mode identifier. Specifically, encoded data generator 440 generates the encoded data that includes a bit string of the residual block encoded by encoder 420 and a bit string of the mode information generated by mode info generator 430.

In an aspect, the encoded data means data generated from encoding by the video encoding apparatus with respect to input data for an input video or block divisions of the input data by the predetermined block unit. The encoded data may be compressed data of the input data through a compression in the process of the encoding, but may be uncompressed data even after the encoding process. In addition, the encoded data may be generated in the form of a bit string having a certain sequence such as a bitstream although it is not necessarily so limited but could be generated in packets, and it can be transmitted in a serial order or in parallel without a specific sequence depending on its form.

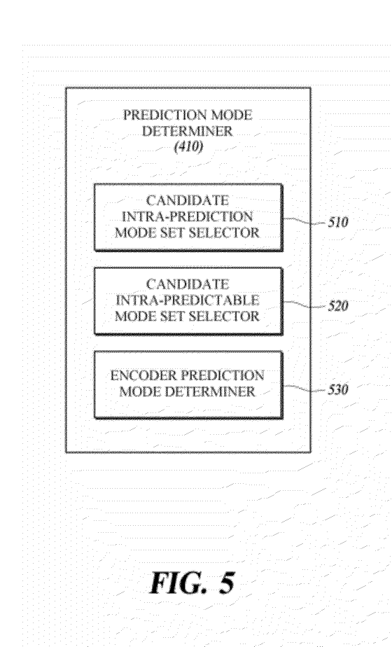

FIG. 5 is a schematic block diagram of prediction mode determiner 410 according to an aspect.

Prediction mode determiner 410 according to an aspect may comprise a candidate intra-prediction mode set selector 510, a candidate intra-predictable mode set selector 520, and an encoder prediction mode determiner 530.

In order to predict the current block to be encoded, candidate intra-prediction mode set selector 510 selects a candidate intra-prediction mode set (candidate set, CS) that is a set of selectable N intra-prediction mode candidates. Here, the candidate intra-prediction mode set may be the nine intra-prediction modes for the intra_{—}4×4 prediction as recommended by H.264/AVC standard, although it is not so limited and may be defined in diverse methods on the premise that the video encoding apparatus and the video decoding apparatus have knowledge of that definition in advance. In other words, for example, the candidate intra-prediction mode set may not only be selected as intra-prediction modes diversified by how the video encoding apparatus and video decoding apparatus are implemented or by their requirements or depending on the application in implementation or by the video sequence but also be selected as needed by the current block to be encoded, that is, by blocks or by block sizes.

Candidate intra-predictable mode set selector 520 makes a determination with respect to each of the N intra-prediction mode candidates in the candidate intra-prediction mode set selected by candidate intra-prediction mode set selector 510 whether the video decoding apparatus can predict thereof following a predetermined criterion of determining a predictability by the decoding apparatus (that is, whether the video decoding apparatus can autonomously select the corresponding intra-prediction mode candidate as the decisive candidate for deciding the intra-prediction mode or the intra-prediction mode candidate in the candidate intra-prediction mode set), and reconstitutes the candidate intra-predictable mode set including number M(N≧M) of intra-prediction mode candidates which are predictable by the video decoding apparatus. Here, an example of the predetermined criterion of determining a predictability by the decoding apparatus may be expressed as Equation 1.

$${ipm}_{dec} = {argmin}_{ipmc ∈ CS} g ( ipmc ) \\ g ( ipmc ) = {\sum }_{i , j ∈ BMS} {[ Ref ( i ) - \{ {Cur}_{pred} ( ipmc , j ) + {Cur}_{residue} ( {ipm}_{cur} , j ) \} ]}^{2} \qquad Equation 1$$

Referring to Equation 1, when functions g(□) of Equation 1 are calculated with respect to all intra-prediction mode candidates ipmc included in the intra-prediction mode candidate set CS which the corresponding block can select, the intra-prediction mode candidate having the lowest g(□) value may be expressed as ipm_{dec} and whether or not ipm_{dec} and ipm_{cur} are equal becomes the criterion of determining a predictability by the decoding apparatus.

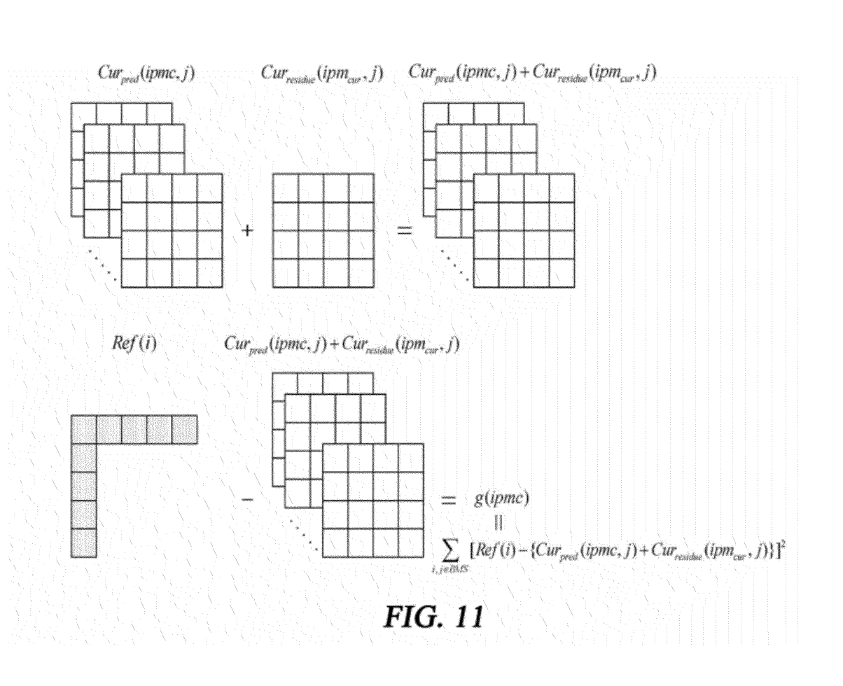

As illustrated in FIG. 11, the functions g(□) are used in this aspect to determine the predictability by the video decoding apparatus as a boundary matching algorithm (BMA), although it is not so limited and may be defined in diverse methods on the premise that the video encoding apparatus and the video decoding apparatus have common knowledge of that definition in advance. For example, an improved boundary matching scheme may be used wherein definitions of pixel values are varied depending on the directional characteristics of the respective candidate intra-prediction modes.

Referring to FIG. 11 for illustrating a boundary pixel matching algorithm along with Equation 1, with respect to the current or neighboring block pixel values included in the boundary matching set (BMS) that is a group of pixels defined by index i for indicating block boundary pixel position in the neighboring block and the corresponding index j position in the current block at the block boundary, for the purpose of boundary pixel matching, the boundary pixel matching method may use the current block predicted pixel value Cur_{residue}(ipm_{cur,j}) reconstructed by using a candidate intra-prediction mode ipmc, value Cur_{residue}(ipm_{cur,j}) for representing the differential value of the current block pixel from the predicted pixel value of the current block reconstructed by using the candidate intra-prediction mode under a decision process as to the decoder predictability for the current block, and the previously reconstructed neighboring block pixel value Ref(i).

Firstly, through adding the current block predicted pixel value reconstructed by using a candidate intra-prediction mode to the differential value (intra-prediction residual signal) between the current block predicted pixel value reconstructed by using the candidate intra-prediction mode under the decision process as to the predictability for the current block, an arbitrary current block pixel value is reconstructed. The difference between the reconstructed current block pixel value and its neighboring block pixel value is determined as a prediction error, and the candidate intra-prediction mode ipmc causing the smallest prediction error is named the decoder prediction mode ipm_{dec} which the video decoding apparatus determines as the intra prediction mode.

Therefore, if the intra-prediction mode ipm_{cur} under a decision process as to the decoder predictability for the current block intra prediction mode ipm_{cur} and the decoder prediction mode ipm_{dec} that is the predictable intra-prediction mode in the video decoding apparatus are concluded to be same, then the video decoding apparatus can autonomously determine its intra-prediction mode, and thus the corresponding intra-prediction mode may be included in the M intra-prediction mode candidates of the candidate intra-predictable mode set to be reconstructed. However, if ipm_{cur} and ipm_{dec} of the video encoding apparatus and decoding apparatus are different, the video decoding apparatus by itself has no predictability on the intra-prediction mode, holding the corresponding intra-prediction mode from being included in the M intra-prediction mode candidates of the candidate intra-predictable mode set to be reconstructed.

To be specific on the process of reconstructing such candidate intra-predictable mode set, a first step starts by an empty set of a candidate intra-predictable mode set (CS') where the current block intra-prediction mode is assumed to be ‘mode 1’ which is used to generate a residual block A1, mimicking the video decoding apparatus by adding a predicted value C1 obtained by using block boundary values B (already known to the video decoding apparatus as current block's adjacent pixel values) through a prediction in the direction of mode 1 to residual block A1 (that is, A1+C1) to obtain a (hypothetical) result of reconstruction, next obtaining a boundary difference (or block boundary matching error E1) by using a block boundary matching through Equation 1, again simulating video decoding apparatus by adding a predicted value C2 obtained by using the block boundary values B through a prediction in the direction of mode 2 to residual block A1 (that is, A1+C2) to obtain a (hypothetical) result of reconstruction, next obtaining a boundary difference (E2) by using BMS, repeating these substeps toward directions of modes 3 to N to obtain E1 through EN, and then finding the smallest value from E1 through EN in order to include mode 1 in CS′ if the smallest value is E1 or if not, hold mode 1 from being included in CS′. In second step, the current block intra-prediction mode is assumed to be mode 2 which is used to generate a residual signal A2 (same as the step 1 but only using A2 instead of A1), and step 1 is followed to obtain E1 through EN and find the smallest value from E1 through EN in order to include mode 2 in CS′ if the smallest value is E2 or if not, hold mode 2 from being included in CS′. Carrying out the above steps can reconstruct the candidate intra predictable mode set.

The above process is carried out through the entire intra-prediction mode candidates of the N candidate intra-prediction mode set, and then candidate intra-predictable mode set selector 520 gathers predictable intra-prediction mode candidates only to reconstruct the candidate intra-predictable mode set. This is why the number M of intra-predictable mode candidates of the reconstructed candidate intra-predictable mode set in candidate intra-predictable mode set selector 520 is always smaller than or equal to the number N of intra-prediction mode candidates of the selected candidate intra-prediction mode set in candidate intra-prediction mode set selector 510 (that is N≧M).

Depending on the number of the reconstructed candidate intra-predictable mode sets in candidate intra-predictable mode set selector 520, encoder intra-prediction mode determiner 530 performs either a first intra-prediction mode selection method or a second intra-prediction mode selection method. In other words, if the number of intra-predictable mode candidates in the reconstructed candidate intra-predictable mode set in candidate intra-predictable mode set selector 520 is greater than a preset number (for example, M≧1), intra-prediction mode determiner 530 sees that the video decoding apparatus has its autonomous predictability of the encoder prediction mode and follows the predetermined first intra-prediction mode selection method to determine the encoder prediction mode that is the current block intra-prediction mode. To the contrary, if the number of intra-predictable mode candidates in the reconstructed candidate intra-predictable mode set in candidate intra-predictable mode set selector 520 is smaller than the preset number (for example, M<1), intra-prediction mode determiner 530 sees that the video decoding apparatus lacks an autonomous predictability of the encoder prediction mode and follows the predetermined second intra-prediction mode selection method to determine the encoder prediction mode that is the current block intra-prediction mode.

Here, a first encoding method is carried out if the number of intra-prediction mode candidates in the reconstructed candidate intra-predictable mode set in candidate intra-predictable mode set selector 520 is greater than the preset number to determine from M intra-prediction mode candidates an intra-prediction mode ipmₒₚₜ that satisfies a predetermined optimal encoding criterion as the encoder prediction mode and decide that the encoder prediction mode is predictable by the video encoding apparatus. In this case, the predetermined optimal encoding criterion may be a rate-distortion cost (R-D Cost) considering the bit rate and distortion which occur from predicting and encoding the current block for each of the intra-prediction mode candidates in the candidate intra-predictable mode set, although this not a necessary limitation but any other criteria may be used as long as they show optimal encoding performances. Equation 2 represents an exemplary operation of determining an intra-prediction mode by using a rate-distortion optimal function.

$${ipm}_{opt} = {argmin}_{ipmc ∈ {CS}^{′}} f ( ipmc ) \\ f ( ipmc ) = D ( ipmc ) + λ \{ {R}_{residue} ( ipmc ) + {R}_{mode} ( ipmc ) + {R}_{flag} ( ipmc ) \} \qquad Equation 2$$

In Equation 2, ipmc represents intra-prediction mode candidates included in the candidate intra-predictable mode set, and ipmₒₚₜ represents an intra-prediction mode determined by a predetermined optimal encoding criterion, i.e. an optimal intra-prediction mode among M intra-prediction mode candidates of the reconstructed candidate intra-predictable mode set in candidate intra-predictable mode set selector 520. f(□) is a function according to the optimal selection criteria, and it may be a rate-distortion optimization function to find the optimal intra-prediction mode on the basis of the rate-distortion cost. Here, D indicates a difference between the original image and the reconstructed image, and A is a Lagrangian constant. In addition, R_{residue}, R_{mode} and R_{flag} represent a bit rate required to encode a residual signal, a bit rate required to encode the encoder prediction mode of the corresponding block, a bit rate required to encode identification information for indicating the decoder predictability, respectively. For the sake of convenience in Equation 2, a common Lagrangian constant is used for the functions related to three bit rates R_{residue}, R_{mode} and R_{flag}, although different Lagrangian constants may be used for the respective bit rate functions.

The predetermined second intra-prediction mode selection method is carried out if the number of the reconstructed candidate intra-prediction mode sets in candidate intra-predictable mode set selector 520 is smaller than the preset number, following the predetermined method through a prearrangement between the video encoding apparatus and the video decoding apparatus to determine an intra-prediction mode ipmₒₚₜ as the encoder prediction mode, and decide that the determined encoder prediction mode is unpredictable by the video decoding apparatus autonomously. An example of the predetermined second intra-prediction mode selection method is to determine the intra-prediction mode of the corresponding block that is encoder prediction mode as the most probable mode.

In other words, if it is determined that the predetermined first intra-prediction mode selection method cannot let the video decoding apparatus make an autonomous determination of the encoder prediction mode, the most probable mode of the corresponding block is used as the encoder prediction mode. As with this example, since the most probable mode defined by the predetermined second intra-prediction mode selection method is shared by the video encoding and decoding apparatuses which could perform the common process, the video encoding apparatus is saved from transmitting additional information for identifying the encode prediction mode to the video decoding apparatus.

Alternatively, the predetermined second intra-prediction mode selection method may be defined more variably besides limiting it to the most probable mode. Specifically, the predetermined second intra-prediction mode selection method may be defined by a method of transmitting information of ┌log₂N┐ bit for indicating N intra-prediction modes. Here, the sign ┌X┐ is ceiling function for calculating an integer value that is greater than or equal to X and is always smaller than X+1.

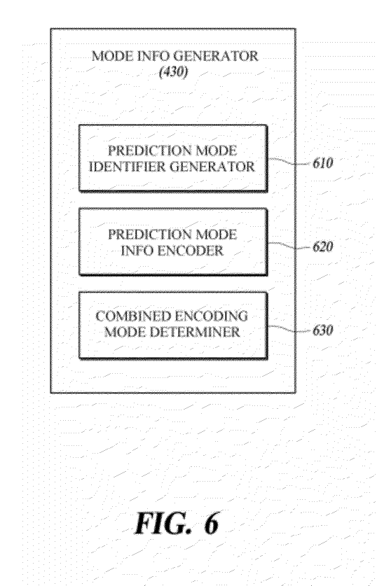

FIG. 6 is a schematic block diagram of a mode information generator according to an aspect.

Mode info generator 430 according to an aspect may comprise a predictable mode identifier generator 610, a prediction mode identifier encoder 620, a combined encoding mode info generator 630.

Depending on whether the video decoding apparatus can predict the determined encoder prediction mode in encoder intra-prediction mode determiner 530 of prediction mode determiner 410, predictable mode identifier generator 610 generates a predictability identifier. For example, predictable mode identifier generator 610 generates flag ‘1’ as the predictability identifier when it determines that the video decoding apparatus can autonomously predict the encoder prediction mode by using the predetermined first intra-prediction mode selection method. On the other hand, predictable mode identifier generator 610 generates flag ‘0’ as the predictability identifier when it determines that the video decoding apparatus is not capable of autonomously predicting the encoder prediction mode by using the predetermined second intra-prediction mode selection method.

In this case, upon receiving flag ‘1’ as the predictability identifier from mode information, the video decoding apparatus uses a predetermined first intra-prediction mode selection method (i.e., the first intra-prediction mode selection method prearranged with the video encoding apparatus) corresponding to the described predetermined first intra-prediction mode selection method to determine the intra-prediction mode of the current block autonomously, and predicts the current block by using the current block intra-prediction mode determined. On the other hand, upon receiving flag ‘0’ as the predictability identifier, the video decoding apparatus uses a predetermined second intra-prediction mode selection method (i.e., the second intra-prediction mode selection method prearranged with the video encoding apparatus) corresponding to the described predetermined second intra-prediction mode selection method to determine the intra-prediction mode of the current block, and predicts the current block by using the current block intra-prediction mode determined.

Prediction mode identifier generator 620 generates a prediction mode identifier only when there is a need to encode the prediction mode identifier for identifying the encoder prediction mode determined by the predetermined second intra-prediction mode selection method, and it may encode the prediction mode identifier that indicates the current block encoder prediction mode determined by prediction mode determiner 410 into information of ┌log₂N┐ bit for indicating the N intra-prediction modes.

Combined encoding mode info generator 630 generates information on combined encoding modes by combining predictability identifiers resulting from the decoder predictability status with respect to each of the blocks included in a predetermined encoding unit. The generation of combined encoding mode information for identifying such combined encoding modes may by the predetermined encoding unit. For example, if the combined encoding mode is such a combined predictable mode that allows the video decoding apparatus to predict the encoder prediction modes of the entire blocks in a predetermined encoding unit, the combined encoding mode information may be generated as ‘1’; if the combined encoding mode is such a combined unpredictable mode that does not allow the video decoding apparatus to predict the encoder prediction modes of the entire blocks in the predetermined encoding unit, the combined encoding mode information may be generated as ‘01’; and if the combined encoding mode is such a mixed mode being either predictable or unpredictable that selectively allows the video decoding apparatus to predict the encoder prediction modes of the blocks in the predetermined encoding unit, the combined encoding mode information may be generated as ‘001’.

Further, instead of combining predictability identifiers resulting from the decoder predictability status with respect to each of the blocks included in the predetermined encoding unit to generate the information on the combined encoding modes as in the above implementation, combined encoding mode info generator 630 may step up to a greater unit or so called higher level unit (than the predetermined encoding unit) in which it determines whether to utilize the combined encoding mode and generates information of the same at the higher level unit for delivery to the decoding apparatus. In other words, it may be arranged to generate the information on the combined encoding modes in each of the encoding units included in the corresponding ones of the higher level units and to generate indicating information for such action at the higher level unit and deliver the same to the decoding apparatus. Alternatively, it may be arranged to hold generating the information on the combined encoding modes in each of the encoding units included in the corresponding higher level units but to generate indicating information at the higher level unit that the respective encoding modes have a single piece of combined encoding mode information en bloc and deliver the same to the decoding apparatus. In this case, it is necessary to signal information for telling what combined encoding mode information to the decoding apparatus on top of the generated information at the higher level unit. That is, the combined encoding mode information may be either generated by each encoding unit to construct encoding data or generated in the higher level unit to construct the encoding data.

In addition, the combined encoding mode for each encoding unit may be determined to be one mode in a predetermined encoding unit and corresponding to a predetermined optimal encoding criterion (for example, rate-distortion optimization criterion). In the cases of the combined predictable mode and the combined unpredictable mode which are capable of combining and encoding the predictable identifier in a predetermined encoding unit among the combined encoding modes, since the predictable identifier may be encoded not by the block unit but by the predetermined encoding unit, an optimal intra-prediction mode may be determined by removing R_{flag}(ipmc) from the rate-distortion function as in Equation 3.

f(ipmc)=D(ipmc)+λ{R_{residue}(ipmc)+R_{mode}(ipmc)} Equation 3

Equation 3 also uses a common Lagrangian constant for the functions related to bit rates R_{residue} and R_{mode} for convenience sake, although different Lagrangian constants may be used for the respective bit rate functions.

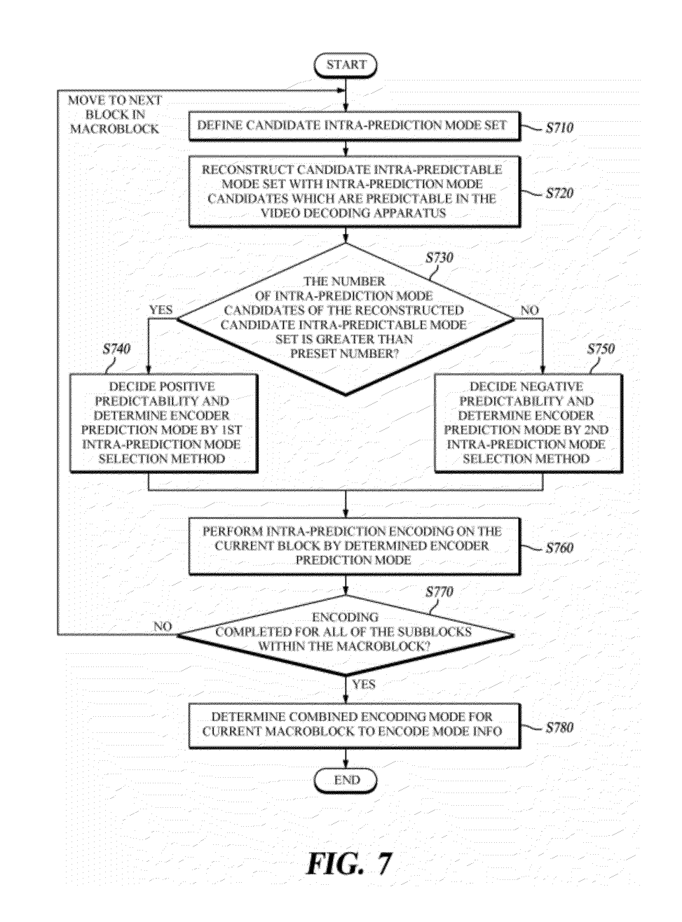

FIG. 7 is a flow diagram for illustrating a video encoding method according to an aspect.

Referring to FIG. 7 in the following, as aspect of the video encoding method will be detailed. When performing an intra-prediction encoding on an image, video encoding apparatus 400 does the same in a predetermined encoding unit such as by macroblock, slice or the like, and in the case of encoding by macroblock, determination of the intra-prediction mode is made by the unit of each subblock and the determined intra-prediction mode is used to perform the intra-prediction encoding.

To this end, video encoding apparatus 400 defines a candidate intra-prediction mode set in step S710, and determines the decoder predictability for the respective intra-prediction mode candidates of the defined candidate intra-prediction mode set to reconstruct a candidate intra-predictable mode set including intra-prediction mode candidates which are predictable in the video decoding apparatus in step S720. Video encoding apparatus 400 determines if the number of intra-prediction mode candidates of the candidate intra-predictable mode set is greater than a preset number in step S730, and if yes, decides the predictability of an encoder prediction mode by the video decoding apparatus in step S740, and if the intra-prediction mode candidates are less than the preset number, decides an unpredictability of the encoder prediction mode by the video decoding apparatus and determine the encoder prediction mode by using a second intra-prediction mode selection method in step 750, and uses the encoder prediction determined in steps S740 or S750 to perform the intra-prediction encoding on the current block in step S760.

Video encoding apparatus 400 determines whether the encoding is completed for all of the subblocks within the macroblock in step S770, and if not, proceeds to step S710 and repeat the steps through step S770 with the next subblock set as the current block, and if the encoding is completed for all of the subblocks, determines the combined encoding mode for the current macroblock to generate and encode mode information in step S780.

At this time, it may be arranged to omit step S780 for when there is no use of the common encoding mode in a predetermined encoding unit.

The illustrated steps and sequence in FIG. 7 are merely for the sake of describing an aspect of the video encoding method and it is not necessary for the disclosed aspect to carry out the steps or be limited to the sequence. Then, some of the described steps may be selectively withheld, extra steps may be performed, the respective steps may be changed in order, or they may even be carried out in parallel. In addition, although FIG. 7 illustrates the aspect of the video encoding method in an assumption that the encoding unit is macroblock, the encoding unit may be defined in various sizes depending on examples implemented.

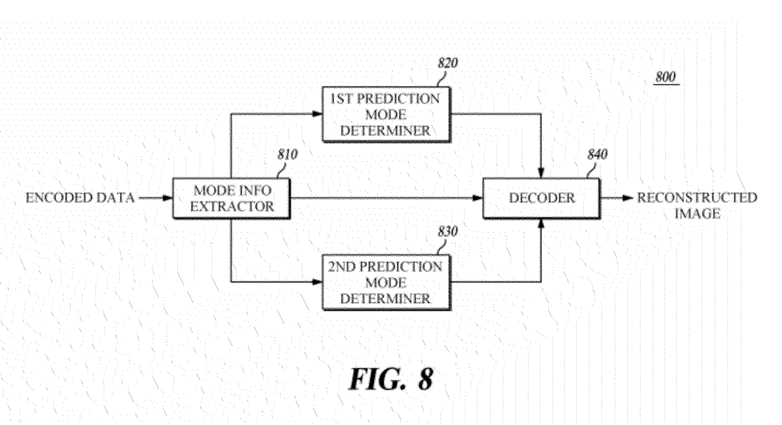

FIG. 8 is a schematic block diagram of a video decoding apparatus 800 according to an aspect.

In FIG. 8, video decoding apparatus 800 may comprise a mode info extractor 810, a first prediction mode determiner 820, a second prediction mode determiner 830, and a decoder 840. Such video decoding apparatus 800 may be a personal computer or PC, notebook or laptop computer, personal digital assistant or PDA, portable multimedia player or PMP, PlayStation Portable or PSP, or mobile communication terminal, smart phone or such devices, and represent a variety of apparatuses equipped with, for example, a communication device such as a modem for carrying out communications between various devices or wired/wireless communication networks, a memory for storing various programs for decoding videos and related data, and a microprocessor for executing the programs to effect operations and controls.

Mode info extractor 810 extracts mode information from encoded data, and analyzes combined encoding mode information contained in the mode information to determine whether it is necessary to extract predictability identifiers for the respective blocks included in a predetermined encoding unit. In this case, if the combined encoding mode information indicates the combined mode, the predictability identifiers of the respective blocks included in a predetermined encoding unit are respectively extracted, and if the combined encoding mode information is either a combined predictable mode or combined unpredictable mode, the predictability identifier is not extracted but depends on the value of the combined encoding mode information to determine the intra-prediction modes of the entire blocks en bloc as being predictable or unpredictable.

First prediction mode determiner 820 operates on blocks having the predictability identifiers indicate their predictability positive from the blocks having their combined encoding modes be the combined predictable mode or mixed mode and included in the predetermined encoding unit to determine the intra-prediction mode of the current block by using a predetermined first intra-prediction mode selection method in a previous agreement with video encoding apparatus 400.

Although an aspect of the present disclosure may use the adjacent pixel matching method as shown in Equation 1 in order to select the intra-prediction mode according to predetermined first intra-prediction mode selection method, various other methods may be used as well as described above. Specifically, first prediction mode determiner 820, in response to the combined encoding mode in the predetermined encoding unit being the combined predictable mode, operates on the entire blocks included in the corresponding encoding unit by calculating decision functions as to predictability status with respect to each of selectable intra-predictable mode candidates and determines the intra-prediction mode candidate having the smallest predictability decision function as the intra-prediction mode of the corresponding block from the selectable intra-predictable mode candidates. Or, first prediction mode determiner 820, in response to the combined encoding mode in the predetermined encoding unit being the mixed mode, operates on the entire blocks having the predictability identifiers indicate their predictability positive by calculating decision functions as to predictability status with respect to each of selectable intra-predictable mode candidates and determines the intra-prediction mode candidate having the smallest predictability decision function as the intra-prediction mode of the corresponding block from the selectable intra-predictable mode candidates.

Second prediction mode determiner 830 operates on blocks having the predictability identifiers indicate their predictability negative from the blocks having their combined encoding modes be the combined unpredictable mode or mixed mode and included in the predetermined encoding unit to determine the intra-prediction mode of the current block by using a predetermined second intra-prediction mode selection method in a previous agreement with video encoding apparatus 400.

Although an aspect of the present disclosure may use the most probable mode in order to select the intra-prediction mode according to predetermined second intra-prediction mode selection method, various other methods may be used as well as described above. Specifically, second prediction mode determiner 830, in response to the combined encoding mode in the predetermined encoding unit being the combined unpredictable mode, operates on the entire blocks included in the corresponding encoding unit by deciding that the intra-prediction modes of the respective blocks cannot be determined by the first intra-prediction mode selection method and thus determines the most probable modes of the respective blocks as the intra-prediction modes of the respective blocks. Or, second prediction mode determiner 830, in response to the combined encoding mode in the predetermined encoding unit being the mixed mode, operates on the entire blocks having the predictability identifiers indicate their predictability negative by deciding that the intra-prediction modes of the corresponding blocks cannot be determined by the first intra-prediction mode selection method and thus determines the most probable modes of the respective blocks as the intra-prediction modes of the respective blocks.

Decoder 840 decodes and then reconstructs the encoded residual blocks for the respective blocks extracted from the encoded data, and adds the reconstructed residual blocks to the predicted blocks generated from predicting the respective blocks according to the respective block intra-prediction modes determined by first prediction mode determiner 820 or second prediction mode determiner 830 in order to reconstruct the respective blocks.

Meanwhile, mode info extractor 810 may be implemented into somewhat modified form. Besides extracting mode information from the encoded data, mode info extractor 810 may be constructed, in response to the mode information being combined encoding mode information generated in a higher level unit with an indication that predetermined encoding units included in the higher level units than the ones under current decoding operation are entirely combined predictable modes or combined unpredictable modes, to spare extracting the combined encoding mode information by the respective encoding units included in the higher level unit. This is because the combined encoding mode in the respective encoding units is already known to be a combined predictable mode or combined unpredictable mode from the extracted higher level unit information. On the other hand, mode info extractor 810 may be constructed, in response to the extracted mode information from the encoded data indicating that the predetermined encoding units included in the higher level units than the ones under current decoding operation are not entirely combined predictable modes or combined unpredictable modes, to extract the mode information indicating the combined encoding mode by the respective encoding units as in the above example of implementation.

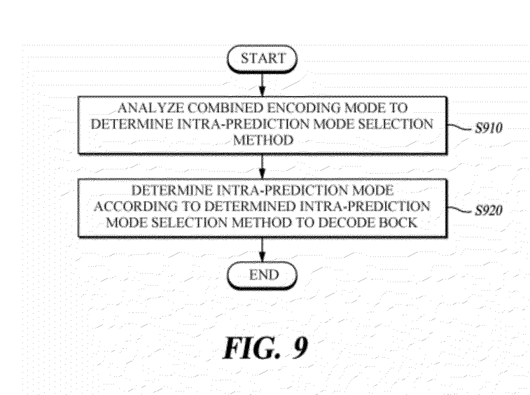

FIG. 9 is a flow diagram for illustrating a video decoding method according to an aspect.

Referring to FIG. 9, video decoding apparatus 800 according to an aspect analyzes combined encoding mode information in mode information extracted from the encoded data to determine the intra-prediction mode selection methods for the respective blocks in step S910, and determines the intra-prediction modes of the respective blocks according to the determined intra-prediction mode selection methods to decode and reconstruct the respective blocks by using the determined intra-prediction modes in step S920.

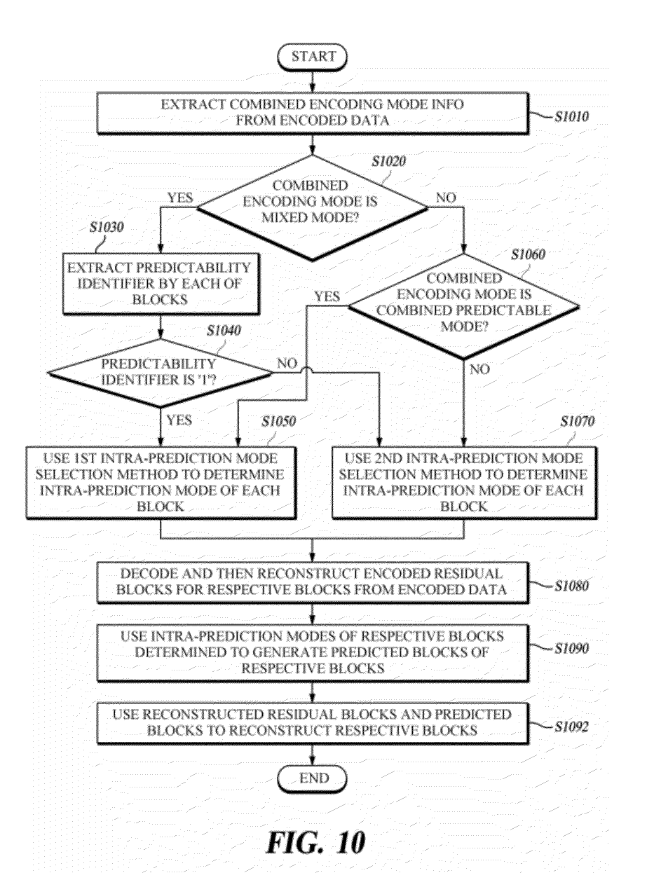

FIG. 10 is a flow diagram for illustrating an exemplary video decoding method according to an aspect.

Video decoding apparatus 800 according to an aspect extracts mode information including one or more of combined encoding mode information, a predictability identifier, and a prediction mode identifier from the encoded data in a predetermined encoding unit such as by macroblock, slice or the like in step S1010, and analyzes combined encoding mode information to determine whether or not the combined encoding mode is the mixed mode in step 1020.

If the combined encoding mode is the mixed mode, video decoding apparatus 800 extracts the predictability identifier by each of the entire blocks in a predetermined encoding unit in step S1030, and determines whether the extracted predictability identifier indicates the positive predictability in step S1040, and if yes (for example, the predictability identifier is ‘1’), uses the first intra-prediction mode selection method to determine the intra-prediction mode of the corresponding block in step S1050, while if the extracted predictability identifier indicates an unpredictability (for example, the predictability identifier is ‘0’), uses the second intra-prediction mode selection method to determine the intra-prediction mode of the corresponding block in step S1060.

Additionally, if the combined encoding mode is not the mixed mode, video decoding apparatus 800 determines whether or not the combined encoding mode is the combined predicable mode (S1070), and if yes, uses the first intra-prediction mode selection method to determine the intra-prediction mode of each block as in step S1050, while if the extracted predictability identifier indicates an unpredictability, uses the second intra-prediction mode selection method to determine the intra-prediction mode of each block as in step S1060. However, although steps S1050 and S1070 operated on those blocks that have the predictability identifiers indicate the predictability and unpredictable from the blocks in the respective predetermined encoding units, if the combined encoding mode is the combined predictable mode and the combined unpredictable mode respectively, then the entire blocks in the respective predetermined block units are processed by using the first intra-prediction mode selection method and the second intra-prediction mode selection method to determine the intra-prediction modes of the entire blocks.

From the encoded data, video decoding apparatus 800 decodes and then reconstructs the encoded residual blocks for the respective blocks in the predetermined encoding unit (S1080), uses the intra-prediction modes of the respective blocks determined in steps S1050 or S1070 to generate predicted blocks of the respective blocks (S1090), and adds the reconstructed residual blocks for the respective blocks to the current blocks to reconstruct the respective blocks (S1092).

As described above, according to an aspect, video encoding apparatus 400 reconstructs such candidate intra-predictable mode set that only includes the intra-prediction mode candidates predictable by video decoding apparatus 800 from the candidate intra-prediction mode set, and depending on the number of the intra-prediction mode candidates in the reconstructed candidate intra-predictable mode set, determines whether video decoding apparatus 800 can predict the encoder prediction mode to determine the intra-prediction mode selection method and accordingly determine the intra-prediction mode, whereby video decoding apparatus 800 can determine the current block intra-prediction mode by using such intra-prediction mode candidates only that video decoding apparatus 800 can autonomously predict from all the available intra-prediction mode candidates, and therefore there is a better probability to determine those predictable encoder prediction modes by video decoding apparatus 800 for the respective blocks.

In this case, since video decoding apparatus 800 can predict the encoder prediction modes, video encoding apparatus 400 needs not transmit identification information for identifying the encoder prediction mode to video decoding apparatus 800, and thereby substantially decreases the bit rate of the encoded data. In addition, with the candidate intra-predictable mode set used for determining the encoder prediction mode, there is increased probability to determine the encoder prediction modes that are predictable for the corresponding block by video decoding apparatus 800, eventually decreasing the bit rate of the encoded data.

Additionally, according to an aspect, if video encoding apparatus 400 determines the combined encoding modes by the predetermined encoding unit so that the predictability identifiers of the entire blocks in predetermined encoding unit totally indicate either the positive predictability or the negative predictability, an identifier needs not be included in the encoded data to indicate the predictability status at every block and thereby the bit rate for the predictability identifiers can be dramatically decreased, resulting in an improvement of the encoding efficiency.

The following describes the result of an experiment on the performance of video encoding apparatus 400 and the video encoding method according to an aspect.

To evaluate the performance of the video encoding method of the aspect, the same method was implemented based on Joint model (JM) reference software version 12.2. Table 1 shows the detailed test environment for the performance evaluation. As shown in Table 1, test video sequences in the resolution of 720p were used. The test video sequences were encoded with the quantization parameter (QP) varied from 28 to 40, and the experiment was carried out in the baseline profile of the H.264/AVC standard.

TABLE 1

| | |
|---|---|
| Sequences | Night, Jets, Bigships, Crew, Raven |
| Resolution | 720p (1280 × 720) |
| Frame rate | 60 Hz |
| Total frames | 100 frames |
| Codec | JM 12.2 |
| QP(I) | 28, 32, 36, 40 |
| GOP | I only |
| Apply to | 4 × 4 block only |
| Coding tool | CAVLC, RDO = On |
| Performance | JM 12.2 |
| Comparison | JM 12.2 with the proposed method |

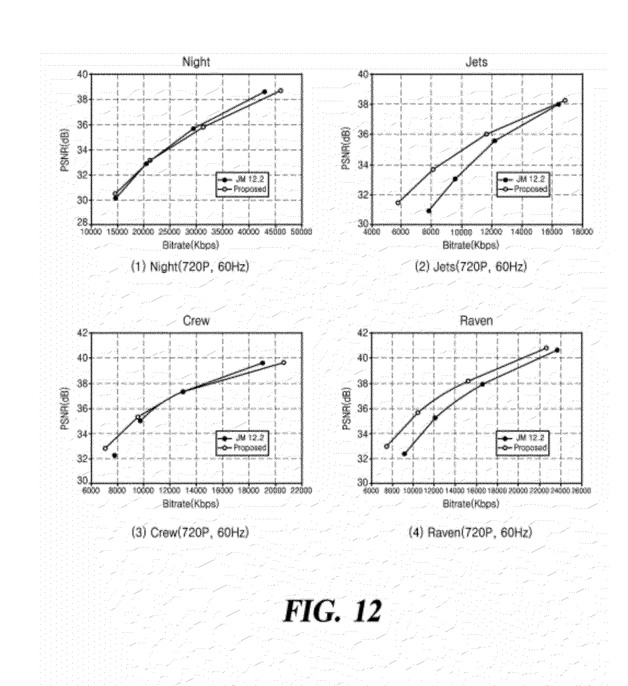

FIG. 12 is an exemplary diagram for illustrating empirical results according to an aspect, representing comparisons of rate-distortion performances of HD video.

The performance of the video encoding method of the aspect changes by the respective video, and Jets and Raven video sequences show particularly excellent performances. This is because Night, Crew, and Bigships video sequences have more complex details than the Jets or Raven video sequences. As an image gets more complex, there are less similar intra-prediction modes generated which proportionally lowers the frequency of skip mode occurrences. For this reason, Night and Crew video sequences cause a cross over to occur at a certain bit rate.

As illustrated, according to an aspect of the present disclosure, merely one bit is spent instead of H.264/AVC standard transmitting one bit or four bits. Moreover, in the event where the encoder prediction modes of a certain threshold number or more of blocks are predictable in the video decoding apparatus leaving the remaining blocks' encoder prediction modes possibly unpredictable by the video decoding apparatus, since the present disclosure sends no bit flags for identification information on the encoder prediction mode of the corresponding blocks, its performance substantially excels the existing H.264/AVC standard in the aspect of overall bit rate. The result of the experiment of the video encoding method according to an aspect surpasses the H.264/AVC standard by approximately 3.08% reduction of bit rate and 0.30 dB enhancement of picture quality on average. In particular, the video encoding method according to an aspect may be more effective at lower bit rates.

In the description above, although all of the components of the embodiments of the present disclosure may have been explained as assembled or operatively connected as a unit, the present disclosure is not intended to limit itself to such aspects. Rather, within the objective scope of the present disclosure, the respective components may be selectively and operatively combined in any numbers. Every one of the components may be also implemented by itself in hardware while the respective ones can be combined in part or as a whole selectively and implemented in a computer program having program modules for executing functions of the hardware equivalents. Codes or code segments to constitute such a program may be easily deduced by a person skilled in the art. The computer program may be stored in computer readable media, which in operation can realize the aspects of the present disclosure. As the computer readable media, the candidates include magnetic recording media, optical recording media, and carrier wave media.

In addition, terms like ‘include’, ‘comprise’, and ‘have’ should be interpreted in default as inclusive or open rather than exclusive or closed unless expressly defined to the contrary. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although exemplary aspects of the present disclosure have been described for illustrative purposes, those skilled in the art will appreciate that various modifications, additions and substitutions are possible, without departing from essential characteristics of the disclosure. Therefore, exemplary aspects of the present disclosure have not been described for limiting purposes. Accordingly, the scope of the disclosure is not to be limited by the above aspects but by the claims and the equivalents thereof.

### INDUSTRIAL APPLICABILITY

As described above, the present disclosure is highly useful for application in the field of video processing technique for compressing video in order to reduce the bit rate required to encode the video for improving the encoding efficiency and enhancing the picture quality of the compressed video.

### CROSS-REFERENCE TO RELATED APPLICATION

If applicable, this application claims priority under 35 U.S.C §119(a) on Patent Application No. 10-2009-0060898 filed in Korea on Jul. 4, 2009, the entire content of which is hereby incorporated by reference. In addition, this non-provisional application claims priority in countries, other than the U.S., with the same reason based on the Korean Patent Application, the entire content of which is hereby incorporated by reference.

1. A video encoding apparatus comprising:
an intra-prediction mode determiner for determining an intra prediction mode of a current block entitled an encoder prediction mode by using a candidate intra-predictable mode set including intra-prediction mode candidates being selected from a whole and predictable by a video decoding apparatus;
an encoder for encoding a residual block generated by subtracting a predicted block from predicting the current block according to the encoder prediction mode from the current block;
a mode information generator for generating mode information depending on whether or not the video decoding apparatus can predict the encoder prediction mode; and
an encoded data generator for generating encoded data including an encoded residual block and the mode information.

2. The video encoding apparatus of claim 1, wherein the intra-prediction mode determiner is responsive to the number of the intra-prediction mode candidates in the candidate intra-predictable mode set being equal to or greater than a preset number for determining the encoder prediction mode by using a predetermined first intra-prediction mode selection method.

3. The video encoding apparatus of claim 2, wherein the first intra-prediction mode selection method determines a single intra-prediction mode candidate being selected from the intra-prediction mode candidates in the candidate intra-predictable mode set and satisfying a predetermined optimal encoding criterion as the encoder prediction mode.

4. The video encoding apparatus of claim 3, wherein the first intra-prediction mode selection method decides that the predetermined optimal encoding criterion is satisfied if a rate-distortion cost is low, the rate-distortion cost considering a bit rate and a distortion occurring from predicting and encoding the current block for each of the intra-prediction mode candidates in the candidate intra-predictable mode set.

5. The video encoding apparatus of claim 1, wherein the intra-prediction mode determiner is responsive to the number of the intra-prediction mode candidates in the candidate intra-predictable mode set being less than a preset number for determining the encoder prediction mode by using a predetermined second intra-prediction mode selection method.

6. The video encoding apparatus of claim 5, wherein the second intra-prediction mode selection method is for determining a most probable mode of a corresponding block as the encoder prediction mode.

7. The video encoding apparatus of claim 1, wherein the mode information generator generates combined encoding mode information for identifying a combined encoding mode for blocks in a predetermined encoding unit as the mode information.

8. The video encoding apparatus of claim 7, wherein the mode information generator determines a combined predictable mode as the combined encoding mode from a decision that the video decoding apparatus can predict encoder prediction modes of entire blocks in the predetermined encoding unit.

9. The video encoding apparatus of claim 8, wherein the mode information generator determines a combined unpredictable mode as the combined encoding mode from a decision that the video decoding apparatus cannot predict the encoder prediction modes of the entire blocks in the predetermined encoding unit.

10. The video encoding apparatus of claim 8, wherein the mode information generator determines a mixed mode as the combined encoding mode from a decision that the video decoding apparatus can selectively predict the encoder prediction modes of the blocks in the predetermined encoding unit.

11. The video encoding apparatus of claim 10, wherein the mode information generator operates on each of the blocks in the predetermined encoding unit for generating a predictability identifier for identifying whether or not the video decoding apparatus can predict the encoder prediction mode of said each of the blocks and including the predictability identifier as an addition in the mode information.

12. The video encoding apparatus of claim 11, wherein the mode information generator operates on the block having the encoder prediction mode decided to be unpredictable by the video decoding apparatus for generating a prediction mode identifier for identifying the encoder prediction mode and including the prediction mode identifier as an addition in the mode information.

13. A video encoding method comprising:
determining an intra prediction mode of a current block entitled an encoder prediction mode by using a candidate intra-predictable mode set including intra-prediction mode candidates being selected from a whole and predictable by a video decoding apparatus;
encoding a residual block generated by subtracting a predicted block from predicting the current block according to the encoder prediction mode from the current block;
generating mode information depending on whether or not the video decoding apparatus can predict the encoder prediction mode; and
generating encoded data including an encoded residual block and the mode information.

14. A video decoding apparatus comprising:
a mode information extractor for extracting mode information from encoded data;
a first intra-prediction mode determiner for determining an intra-prediction mode by using a first intra-prediction mode selection method with respect to the entirety of blocks included in a predetermined encoding unit if a combined encoding mode identified by the mode information is a combined predictable mode and with respect to the blocks being selected from the entirety included in the predetermined encoding unit and indicated as predictable by a predictability identifier identified by the mode information if the combined encoding mode is a mixed mode;
a second intra-prediction mode determiner for determining the intra-prediction mode by using a second intra-prediction mode selection method with respect to the entirety of blocks included in the predetermined encoding unit if the combined encoding mode identified by the mode information is a combined unpredictable mode and with respect to the blocks being selected from the entirety included in the predetermined encoding unit and indicated as unpredictable by the predictability identifier identified by the mode information if the combined encoding mode is the mixed mode; and
a decoder for decoding and reconstructing an encoded residual block for each of blocks extracted from the encoded block and adding a reconstructed residual block to a predicted block from predicting each block according to an intra-prediction mode of each block determined by the first intra-prediction mode determiner or the second intra-prediction mode determiner.

15. A video decoding method comprising:
extracting mode information and an encoded residual block from encoded data;
decoding and then reconstructing the encoded residual block;
determining an intra-prediction mode selection method according to extracted mode information;
determining an intra-prediction mode of a block by using a determined intra-prediction mode selection method; and
reconstructing the block by using a reconstructed residual block and a predicted block generated from predicting the block by using the determined intra-prediction mode selection method.

16. The video decoding method of claim 15, wherein the step of determining the intra-prediction mode selection method comprises:
deciding whether or not a combined encoding mode identified by the mode information is a mixed mode;
extracting a predictability identifier for each of blocks in a predetermined unit if the combined encoding mode is the mixed mode;
determining the intra-prediction mode of the block by using a first intra-prediction mode selection method if the predictability identifier indicates a positive predictability;
determining the intra-prediction mode of the block by using a second intra-prediction mode selection method if the predictability identifier indicates a negative predictability;
deciding whether or not the combined encoding mode is a combined predictable mode if the combined encoding mode is not the mixed mode;
determining the intra-prediction mode by using the first intra-prediction mode selection method with respect to the entirety of blocks in the predetermined unit if the combined encoding mode is the combined predictable mode; and
determining the intra-prediction mode by using the second intra-prediction mode selection method with respect to the entirety of blocks in the predetermined unit if the combined encoding mode is the combined unpredictable mode.
